(19) United States
(12) Patent Application Publication
(10) Pub. No.: US 2018/0012400 A1
(43) Pub. Date: Jan. 11, 2018

(54) CONTINUOUS AND DYNAMIC LEVEL OF DETAIL FOR EFFICIENT POINT CLOUD OBJECT RENDERING

(71) Applicant: Microsoft Technology Licensing, LLC, Redmond, WA (US)

(72) Inventor: Patrick Wayne John EVANS, Redmond, WA (US)

(21) Appl. No.: 15/629,740

(22) Filed: Jun. 22, 2017

Related U.S. Application Data
(63) Continuation of application No. 13/742,354, filed on Jan. 16, 2013, now abandoned.

(51) Int. Cl. G06T 17/00

(52) U.S. Cl. CPC G06T 17/00; G06T 2210/36; G06T 2210/56

(57) ABSTRACT

Rendering real-time three-dimensional computer models is a resource-intensive task, and even more so for point cloud objects. Level of detail is traditionally performed using a small number of fixed-size independent models. A new system is presented of rendering point cloud objects with efficient dynamic level of detail. Several novel point cloud dynamic level of detail techniques are presented that are fairly simple to implement and significantly more efficient in terms of managing rendering load, data reduction, and memory consumption. The novel point cloud dynamic level of detail techniques can be employed to optimize or otherwise improve the rendering efficiency of rendering point cloud objects.

### TECHNICAL FIELD

The technical field relates generally to three dimensional geometric rendering using point cloud methods for computer graphics, and more particularly relates to techniques for optimizing computer resources (e.g., memory, CPU, etc.) for the graphical rendering of point cloud objects.

### BACKGROUND

Rendering real-time views of a three-dimensional computer models is a resource-intensive task. Classically, physical real-world objects are represented by a three-dimensional geometric model based upon vertices and edges which approximate the surface, texture and location of the real-world object. Thus, these objects are stored in a computer medium as a collection of polygons which are collected together to form the shape and visual and characteristics of the encoded real-world object. Alternatively, point clouds represent objects not as a collection of polygons, but rather as a sample of points representative of, and located on, the external surface (interior-inclusive, or interior-exclusive) of an object.

A point cloud is a set of vertices, often considerably large, having at least three-dimensional coordinates; these vertices are often defined by the classic 3-tuple (X, Y, Z) of three-dimensional rendering coordinates. Point clouds are used in situations where sampling a real-world object is practical and can produce a detailed representation of the real-world object. Sampling devices obtain a large number of points from the external surface of a real-world object, and output a point cloud array containing the vertices. Point cloud objects are desirable for many rendering applications, including manufactured parts, quality inspection, and a visualization, animation, rendering and mass customization applications.

Typically modern applications use polygonal meshes; point clouds are not commonly supported in commercial rendering applications with regards to manipulation, modification, creation and alteration. To manipulate point clouds, applications will convert the point cloud external surfaces into directional polygonal or tessellated triangle meshes, spline-form surfaces, or voxel models through surface data inspection and reconstruction. Further, common methods for rendering (as opposed to manipulating) point clouds similarly rely on conversion into polygonal meshes and then allow for common methods of manipulation, modification and alteration. In this manner, traditional models of progressive meshes and rendering techniques apply.

When rendering scenes containing advanced geometry, rendering complexity and performance are utmost resource considerations, and are managed carefully. A reduction in object complexity leads to improved rendering performance. A technique for reducing object complexity in a given scene is to alter the level of detail of the objects. Level of detail commonly involves decreasing the complexity of an object representation as it moves away from the viewer. The efficiency of rendering is improved by decreasing the graphics system load, usually by reducing vertex transformations. The reduced quality of the model is minimized because of the effect on object appearance when the object is rendered in the distance (or when moving at a rate that exceeds viewer perception).

Discrete Level of Detail (DLOD) provides for a fixed set of models, each representing the same object at a differing complexity level. Prior solutions to DLOD for polygonal rendering include pre-generating a fixed set of quantized models and selecting between models during rendering. Polygonal systems also pre-calculate fixed level of detail as mesh merging is computationally difficult, or resort to complex interpolation or transition methods such as progressive meshes or delta storage, where the differences between levels are stored and referenced during a conversion or mapping process from one level of mesh to another. Other analogous fixed level systems include MIP maps for texture rendering. Conversely, when a mesh is continuously evaluated and an optimized version is produced according to a tradeoff between visual quality and performance in any given frame, the result is Continuous Level of Detail (CLOD).

Point cloud rendering models use a fixed number of points per object, often managed using a space-partitioning method such as an octree or N-dimensional tree. To implement discrete level of detail for a point cloud, fixed octree maps at specific discrete or “quantized” detail levels are formed, thus producing redundant and duplicate copies of data. This process is sometimes referred to as down-sampling. This also causes the visual illusion of “jitter” when an object, viewed during the render of a scene, transitions in Z-depth enough to trigger a move from one quantized level to another. For example, a visual representation of an object may have a low detail, medium detail and high detail, with the low detail shown at far distances, and the high detail shown at close distances. However, these point cloud models do not allow for smooth and dynamic transitioning detail, and are often used at larger viewing distances in the rendered world to avoid changes perceptible by the viewer, thus wasting rendering resources.

To compound the issue, real-world point clouds approximating physical object of any reasonable size can contain millions of points. Consequently, enormous computer resources are required to manage and render point cloud data of this type. Level of detail calculation is even more difficult in such large point cloud situations.

### SUMMARY

In view of the foregoing, the invention provides a system of rendering point cloud objects with efficient continuous and dynamic level of detail. The invention performs a pre-computed reorder and/or resample of a point cloud object in an ordered set in a list form such that attributes of the point cloud are maintained across the entire list. In one embodiment, the N-axis centroid of the vertices of the set is maintained when iterating from the head of the list to the tail of the list. In another embodiment, the average surface point density of the vertices of the set are maintained when iterating from the head of the list to the tail of the list. The pre-computed ordering preserves properties of the point cloud object, specifically the point density when rendering through the list of points from head to tail, within an error tolerance.

An error tolerance for this approximation can be selected. During the rendering process, any level of detail can be specified dynamically and continuously rendered at a known cost from minimum detail, such as a single point or a minimum set, to maximum detail including the entire point cloud list, or any continuous level in between by iterating the render list until the desired detail level is reached. In one embodiment, a selection of the level of detail can be obtained by dividing the distance from the PCO to the camera position by the normalized available maximum level of detail. As an animated object travels from far to near the viewing position, the level of detail scales with the object, creating a high performance rendering scenario with minimized perception of point cloud detail change.

To the accomplishment of the foregoing and related ends, certain illustrative aspects of the disclosed and claimed subject matter are described herein in connection with the following description and drawings. Other advantages and novel features will become apparent from the following detailed description when considered in conjunction with the drawings.

### BRIEF DESCRIPTION OF THE DRAWINGS

The system and methods for controlling point cloud rendering in a 3D computer graphics system are further described with reference to the accompanying drawings in which:

FIG. 1 is a block diagram illustrating a computing system operable to execute the disclosed invention.

FIG. 2 is a block diagram illustrating a software and hardware rendering environment in which the invention may be embodied.

FIG. 3 is a block diagram illustrating a technique of producing an ordered point cloud list appropriate for rendering with dynamic level of detail.

FIG. 4 is a block diagram illustrating a technique of rendering an ordered point cloud list in accordance with an embodiment of the invention.

FIG. 5A illustrates rendering a point cloud object leveraging dynamic level of detail, with no cloud points rendered.

FIG. 5B illustrates rendering a point cloud object leveraging dynamic level of detail, where the level of detail is low (N=58).

FIG. 5C illustrates rendering a point cloud object leveraging dynamic level of detail, where the level of detail is moderate (N=551).

FIG. 5D illustrates rendering a point cloud object leveraging dynamic level of detail, where the level of detail is high (N=1558).

FIG. 5E illustrates rendering a point cloud object leveraging dynamic level of detail, where the level of detail is maximum (N=2100).

FIG. 6A illustrates the two dimensional determination of the barycenter of an object in accordance with an embodiment of the invention.

FIG. 6B illustrates the three dimensional determination of the barycenter of an object in accordance with an embodiment of the invention.

### DETAILED DESCRIPTION

Overview

A new and improved method of precomputing (by resampling and/or reordering) point cloud objects to allow for variable or dynamic level of detail is presented. An embodiment can be leveraged on both sides of a 3D point cloud application—during the content production phase of a 3D application, and subsequently during the rendering phase of the 3D application. The developer of the application obtains point cloud lists representing objects to be used in the application. These models are obtained via physical object sampling including methods such as laser, photographic and depth sampling, or alternative methods such as 3D modeling packages. The precomputing phase of the dynamic level of detail method is applied at any stage prior to displaying the point cloud object, including a parallel computation while rendering other content. During the rendering phase, typically real-time, the precomputed level of detail is leveraged to obtain highly efficient and high performance rendering while at the same time producing a desirable visual display.

A point cloud (PC) is a set or “list” of vertices, often considerably large, having at least three-dimensional coordinates; these vertices are typically defined by the classic 3-tuple (X, Y, Z) of three-dimensional rendering coordinates. A point cloud list (PCL) refers to this list of vertices. Point clouds are used in situations where sampling a real-world object is practical and can produce a detailed representation of the real-world object for visual image rendering. Sampling devices obtain a large number of points from the external surface of a real-world object, and output a point cloud array containing the vertices. A point cloud object (PCO) is a point cloud list representing a point cloud for an object.

Level of detail (LOD) is the degree of detail rendered in a given 3D scene. LOD can be specified on a scene basis, or an object basis. A lesser rendering level of detail improves the efficiency and performance of rendering a particular object in a scene. Dynamic level of detail (DLOD) is a method for choosing level of detail based on factors in the scene, such as viewing distance, that can, for point clouds, represents the number of points needed for rendering a given object. A continuous dynamic level of detail entails that the levels are not discrete or are not pre-generated at fixed intervals. However, point clouds can be pre-calculated in ideal ways without the need for mesh merging or fixed levels of detail, thus enabling fast continuous level of detail.

A dynamic level of detail defined in this invention for point clouds can encompass both an actual point count, and also an index representing a position in a point cloud list. In some applications these measures may correspond to the same value. In others, the detail level may be “virtual” and require a mapping function to the actual point count or point index. For example, a detail level may be a floating point value that is rounded to an index. Minimum detail is a single point or a minimum point set necessary for rendering the object. When referring to maximum detail, typically this implies the entire point cloud list, however rendering applications may choose to set a lower maximum detail level to ensure high performance rendering.

Precomputing is a processor-based analysis of an object list, and may refer to both the first computing of a PCL or PCO, either prior to run time, or on the fly during run time, or a later computing that processes an existing PCL or PCO. Recomputing may be used interchangeably with precomputing or recalculation, however the term is sometimes used to refer to the reprocessing of existing data.

An embodiment preserves point density in an ordered point cloud object render list to establish dynamic level of detail. The established dynamic level of detail can then be leveraged through a pre-ordered point cloud list to render a point cloud object using variable or dynamic level of detail. One method of establishing the dynamic level of detail is to use a distance to viewed object as a scalar value to determine the stop element in the point cloud list. A stop element becomes the furthest progression in the list that is iterated to achieve sufficient detail at that level of detail setting. The point cloud object element list allows for a single copy of the object to remain in memory, useful for both rendering and other computational purposes.

Where an embodiment provides for preserving just one copy of the object to render, but with a highly variable degree of LOD, the rendering application benefits from a reduction of overall memory consumption. Further, animated point cloud objects can render variable LOD with low computing cost. However, the primary benefit is the ability to render extensive scenes with very large numbers of PC objects at completely scalable LOD in real time, with only a tiny overhead. In many cases, as described here, this can be as short as calculating the LOD index during rendering for each object. The computing device can also precompute a LOD mapping table to improve that rendering time. No memory need be wasted storing multiple copies at varying fixed LODs, nor is much computing time spent selecting the list to render. Polygonal mesh rendering systems cannot benefit from such a system, as the mesh needs to be compressed or merged at strategic points to approximate the original object. This takes advantage of the linearity of detail in PC objects when sorted or pre-calculated according a uniform attribute rule, such as surface density or barycenter averaging.

LOD Selection

During the rendering process, a level of detail is determined for each object within the viewing frustum. Distance to viewer may be taken to account such that a normalized LOD is calculated by dividing the distance to object by the LOD constant for that object. A maximum and minimum range to object can be selected, and normalized to the maximum and minimum point cloud. Cost may be used to preserve scene rendering speed—any level of detail can be specified and rendered at a known cost, CR=C*(LOD*SF)*PCC from a complete minimum detail (a single point or a constant minimum set C) to maximum detail (the entire point cloud list), or any level in between by iterating the render list until the desired detail level is reached. In this context, CR is the rendering cost, C is the constant invariant point set, LOD represents the selected level of detail, SF represents the scaling factor of points per LOD unit, and PCC is the constant cost of rendering a single cloud point. One example selection of the level of detail can be obtained by dividing the distance from the PCO to the viewing position by the normalized available maximum detail level (ie. point density). This provides for dynamic LOD: as an object travels from far to near the viewing position, the LOD scales with the position of the object.

Object Tree Management

When performing complex rendering, object merging and animation are considerations. Rendering methods for PCLs vary greatly—octrees are a common storage method of PCL data by rendering systems. PCLs sorted using the dynamic method described here may be inserted as a node in an octree, or PCLs may be clustered into sectors, or another rendering method may be used. In general, the methodology for rendering the pre-ordered list at a given LOD is simple: the LOD is computed during the scene (see above, LOD selection), and then each object within the viewing frustum is rendered. The PCL list is rendered, atom by atom, beginning at the head of the list until the LOD index is reached. The LOD index is the array or list item number that is represented by the normalized LOD value selected during LOD selection. This provides for a known linear compute time of a definite cost. To preserve back-facing and hidden object clouds, one embodiment allows for attribution of point cloud elements during the precalculation process, such as with vectors or feature attributes related to the object position, shape or other features. This data is applied over the list via an attribute defined during the precalculation of the PCL ordering, and attributes of particular points may be assigned using identifiers. For example, all points on the hidden side of the cube may be marked with a vector indicating the estimated normal of the cube face to the viewer for backface culling. There are no limits to the number of attributes that one can apply to the nodes, provided that the reordered PCL preserves the attributes in the same way it preserves the level of detail constraints and properties.

Computation Scaling

PCL rendering provides for computational scaling, as LOD can be varied and cost computed to maintain frame rates, or to maintain total number of objects. Further, PCLs are eligible for implementation on polygon-based graphics systems, thus calculating the total polygon load is useful. For voxel-based implementations, LOD is still useful for reducing the total number of voxels to render at a distance where individual voxels are near-impossible to discern. Thus, one embodiment allows for computational scaling and estimation of cost to render for selecting ideal detail levels suited to a particular hardware platform or application configuration.

Exemplary Computer Environments

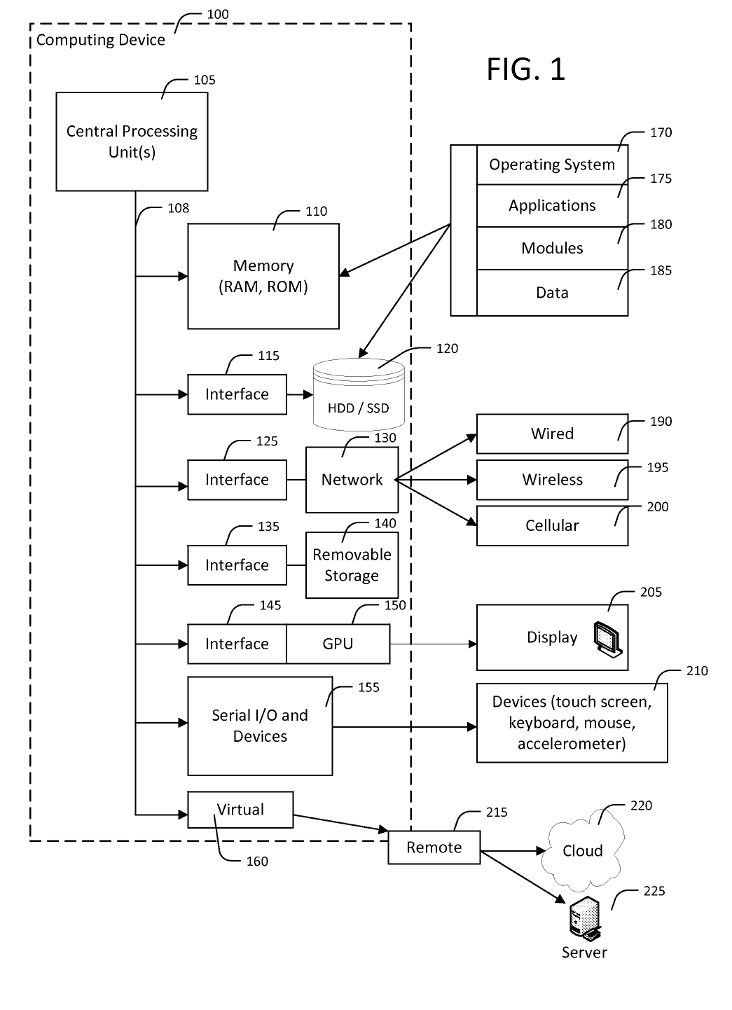

FIG. 1 is intended to illustrate a computing system environment for an embodiment of the invention. Although not required, embodiments of the invention will be described in the general context of computer-executable instructions, such as program modules or applications, being executed by one or more computers, such as client workstations, servers or other devices. Generally, applications include routines, programs, objects, components, data structures and the like that perform particular tasks or implement particular abstract data types. Typically, the functionality of the applications may be combined or distributed as desired in various embodiments. Moreover, those skilled in the art will appreciate that the invention may be practiced with other computer system configurations. Other well-known computing systems, environments, and/or configurations that may be suitable for use with embodiments of the invention include, but are not limited to, personal computers (PCs), server computers, hand-held, slate, mobile or laptop devices, multi-processor systems, microprocessor-based systems, programmable consumer electronics, network PCs, minicomputers, mainframe computers, gaming platforms and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 illustrates an example of a suitable computing system environment 100 in which an embodiment of the invention may be implemented. The computing system environment 100 is only one example of a suitable computing environment and is not intended to suggest any limitation as to the scope of use or functionality of the invention. For example, graphics application programming interfaces may be useful in a wide range of platforms. Neither should the computing environment 100 be interpreted as having any dependency or requirement relating to any one or combination of components illustrated in the exemplary operating environment 100.

In FIG. 1, an exemplary system for implementing an embodiment of the invention includes a general purpose computing device in the form of a computer device 100. Components of computer 100 may include, but are not limited to, a processing unit 105, a system memory 110, and a system bus 108 that couples various system components including the system memory to the processing unit 105. The system bus 108 may be any of several types of bus structures including a memory bus or memory controller, a peripheral bus, and a local bus using any of a variety of bus architectures. By way of example, and not limitation, such architectures include (HT) Hyper Transport, Industry Standard Architecture (ISA), Micro Channel Architecture (MCA), Enhanced ISA (EISA), QuickPath Interconnect (QPI), and Peripheral Component Interconnect [Enhanced] (PCI[e]).

Computing device 100 typically includes a variety of computer readable media. Computer readable media can be any available media that can be accessed by computer 100 and includes both volatile and nonvolatile media, removable and non-removable media. By way of example, and not limitation, computer readable media may comprise tangible computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 100. Communication media typically embodies computer readable instructions, data structures, program modules or other data. While communication media includes non-ephemeral buffers and other temporary digital storage used for communications, it does not include transient signals in as far as they are ephemeral over a physical medium (wired 190 or wireless 195, 200) during transmission between devices. Combinations of any of the above should also be included within the scope of computer readable media.

The system memory 110 includes computer storage media in the form of volatile and/or nonvolatile memory such as read only memory 110 (ROM) and random access memory 110 (RAM). The processing unit 110 and bus 108 allow for transfer of information between elements within computer 110, such as during start-up, typically stored in ROM 110. RAM 110 typically contains data and/or program modules that are immediately accessible to and/or presently being operated on by processing unit 105. By way of example, and not limitation, FIG. 1 illustrates operating system 170, application programs 175, other program modules 180, and program data 185.

The computer 100 may also include other removable/non-removable, volatile/nonvolatile computer storage media. By way of example only, FIG. 1 illustrates a drive 120 that reads from or writes to non-removable, nonvolatile media including NVRAM or magnetic disc, a magnetic disk drive 140 that reads from or writes to a removable, nonvolatile disk, optical disk, solid state disk, or other NVRAM. Other removable/non-removable, volatile/nonvolatile computer storage media that can be used in the exemplary operating environment include, but are not limited to, magnetic tape cassettes, flash memory cards, digital versatile disks, Blu-Ray disks, digital video tape, solid state RAM, solid state ROM, and the like. The hard disk drive 120 is typically connected to the system bus 108 through a non-removable memory interface such as interface 115, or removably connected to the system bus 108 by a removable memory interface, such as interface 135.

The drives and their associated computer storage media discussed above and illustrated in FIG. 1, provide storage of computer readable instructions, data structures, program modules and other data for the computer 100. In FIG. 1, for example, disk drive 120 is illustrated as storing operating system 170, application programs 175, other program modules 180, and program data 185. Note that these components can either be the same as or different from operating system 170, application programs 175, other program modules 180, and program data 185. Operating system 170, application programs 175, other program modules 180, and program data 185 are given different numbers here to illustrate that, at a minimum, they are different copies. A user may enter commands and information into the computer 100 through input devices such as a keyboard 210 and pointing device 210, commonly referred to as a mouse, trackball or touch pad. Other input devices (not shown) may include a microphone, joystick, game pad, satellite dish, depth or motion sensor (such as Microsoft Kinect™), scanner, or the like. These and other input devices are often connected to the processing unit 105 through the system bus 108, but may be connected by other interface and bus structures, such as a parallel port, game port, Firewire™ or a universal serial bus (USB). A monitor 210 or other type of display device is also connected to the system bus 108 via an interface, such as a video interface 145. In addition to the monitor, computers may also include other peripheral output devices such as speakers and printer, which may be connected through an output peripheral interface 155.

The computer 100 may operate in a networked environment using logical connections to one or more remote computers, such as a remote computer 215. The remote computer 215 may be a personal computer, a server, a router, a network PC, a peer device or other common network node, and typically includes many or all of the elements described above relative to the computer 100. When used in a LAN networking environment, the computer 100 is connected to the LAN through a network interface 130. When used in a WAN networking environment, the computer 100 typically establishes communications over the wired adapter 190, wireless adapter 195, or cellular 200. In a networked environment, program modules depicted relative to the computer 100, or portions thereof, may be stored in the remote 215 memory storage device (220 or 225).

Virtual services and data 160 may be provided to the bus 108, CPU 105 and memory 110 via remote interface 215. An example of such virtual services may include a remote server 225 or cloud storage 220. In practical application, virtual services are mounted via the network interface 125 to the physical networking adapters 190, 195 and 220.

Applications 170 accessing 3D rendering services via the graphics interface 145 communicate with the GPU 150 to produce 3D visual display imagery 210. The primary APIs for rendering 145 typically include 2D and 3D libraries to allow easy access to applications 170. Alternatively, imagery from the GPU 150 may be redirected to local memory 110, or to networked devices 130 or cloud services 220.

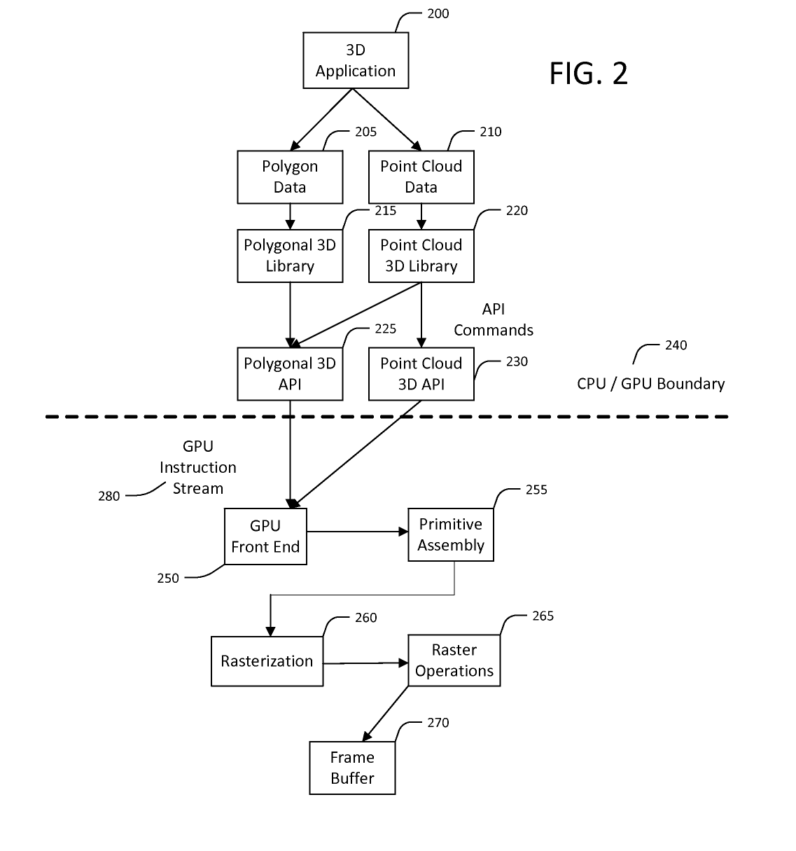

FIG. 2 illustrates application 170 access to the software interface 145 and hardware GPU 150. In particular, 3D application 200 lies on the software/CPU side of the CPU/GPU boundary 240. 3D applications 200 compute 3d geometry and make calls to graphical APIs 225 and 230. If the 3D application 200 is processing polygonal data 205, then the rendering path is via the 3D polygon library 215, which calls the Polygonal 3D API 225. An example of said library and API are GLUT and OpenGL, respectively, or XNA and DirectX. Conversely, if the 3D Application 200 is processing Point Cloud data 210, a Point Cloud library 220 is called, which ultimately calls the Point Cloud 3D API 230.

The Point Cloud 3D Library 220 may transform point cloud data into polygonal form for rendering on a traditional Polygonal 3D Library 225, however modern GPUs are pushing the CPU/GPU Boundary 240 “north” into object space. For example, a Point Cloud management library accepting point cloud data 210 may transform and make calls to the Polygonal 3D API 225 via, for example, tessellation. The role of both the Polygonal 3D API 225 and the Point Cloud 3D API 230 pushes data across CPU/GPU Boundary 240 for rasterization via the GPU instruction stream 280. The GPU is responsible for moving the 3D object information in object space into image space.

The GPU Front End 250 receives GPU instructions 280 from the rendering APIs (225, 230) for processing into a rasterizable format. Primitive assembly 255 involves transforming the 3D data into transformed vertex geometry suitable for rasterization. Rasterization 260 on the GPU produces a stream of fragments from the primitives assembled 255 in the GPU pipeline. The rasterizer 260 executes rasterization operations 265 to write display data into the Frame Buffer 270, a process known as “compositing” of the fragments into an image. Modern rasterizers 260 allow for rasterization programs to customize fragment rendering. The Frame Buffer 270 ultimately holds the composited display image when rasterization 260 is complete. Vertex programs and shader programs may join the pipeline anywhere from the GPU front end 250 to the rasterization process 260 to inject data.

Dynamic Level of Detail for Point Cloud Objects

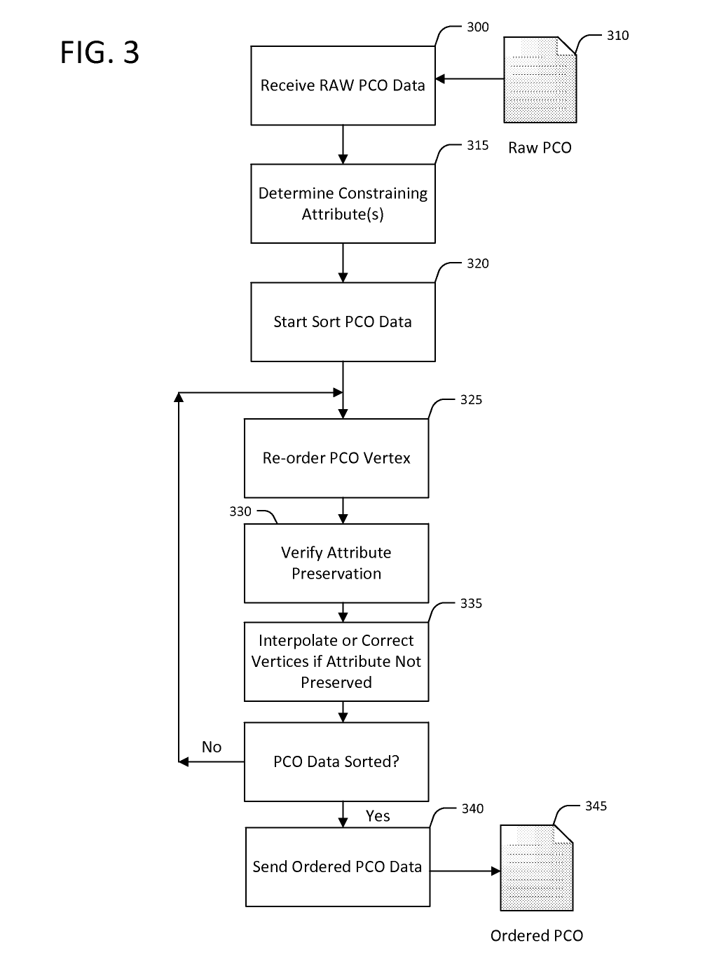

FIG. 3 illustrates the process of a component for recomputing a point cloud list 310 for rendering with dynamic level of detail 345. A raw sampling of an object into point cloud information is called a raw point cloud list (RPCL) or a raw point cloud object (RPCO). A raw point cloud object (RPCO) 310 is received 300 by the processor executing the recomputing process. The receiving 300 by the precomputing component loads the RPCL into memory in an optimally organized format, such as utilizing an indexed data structure such as a b-tree or a linear array list. This allows for high performance reorganization and insertion of new points. This receiving 300 also provides for a local copy, or a reference or pointer to the list in memory where it can be safely altered.

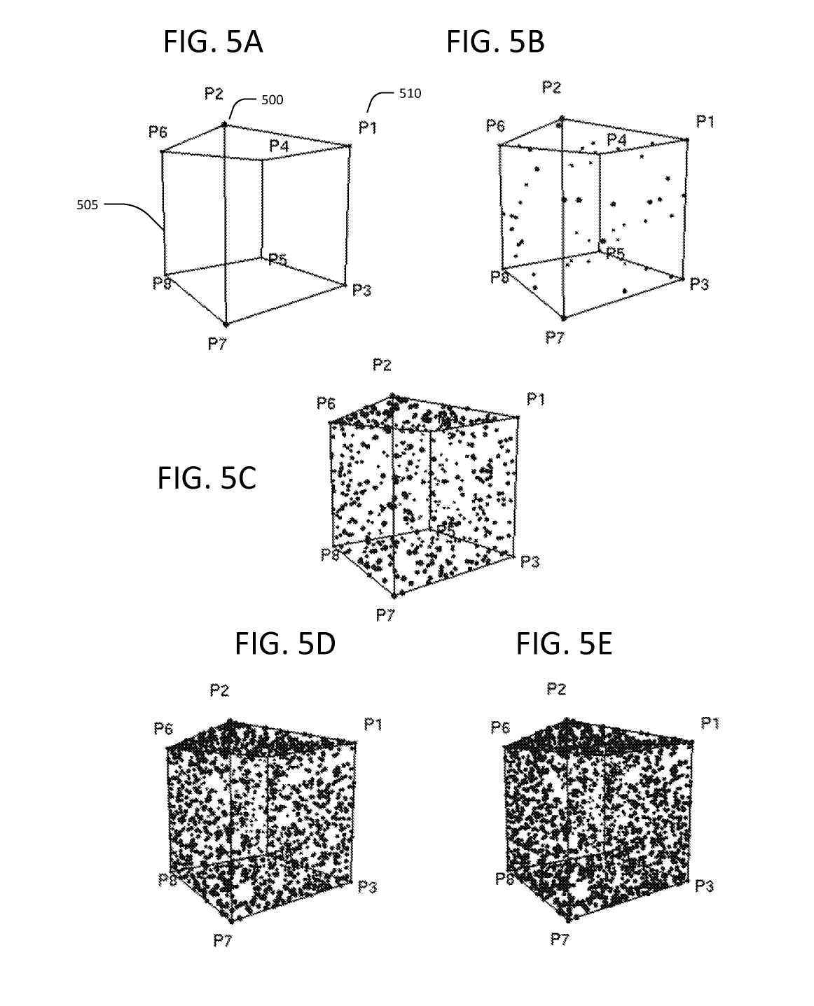

The data structure can be analyzed to determine the barycenter or centroid of the point cloud for future processing steps, and to determine the mandatory and minimum set of points needed to render the object. Any object a sufficient distance from an observer is a single point; thus, a single point is the smallest point set that can be used for the minimum set, however such a set should preferably represent the outline of the object in a recognizable form. For example, as FIG. 5A, a cube would in the minimal form can include just 8 corner points.

When the entire raw point data is available, the processor determines the desired constraining attributes 315 of the recomputing operation of FIG. 3. Such constraints change the character of the ordered point cloud object 345 that is produced from the recomputing. When the precomputing component resamples or reorders, the point cloud object should satisfy certain key attributes that guide the recomputing of FIG. 3. Examples of possible attributes for recomputing include: (1) preservation of the barycenter (either under uniform or non-uniform object density), (2) preservation of the geometric centroid, (3) preservation of 2D facial surface density, (4) preservation of a volumetric density in one or more volumetric spaces, and (5) symmetry across planar partitions. Attributes are likely to vary given the nature of point data, and so the attributes are preserved within an acceptable error bound during the verification step 330. This error bound varies from application to application, and should be tuned to minimize visual defects.

One preferable attribute for preservation is maintenance of the 3D centroid or barycenter of the PCO when iterating from the head of the list to the tail of the list. Such an ordering preserves the point cloud object integrity in a manner during variable LOD rendering. A second attribute of importance is that of maintaining approximate point density per surface when rendering down the list (again, error tolerance can be selected). For example, a cube has six faces, of which the average point density per face or per volume can be maintained by adding a single point to each face of the cube before adding a second point to any face. The first point would typically appear in the center of each face of the cube, however error tolerances or a resistance to resampling would allow for the closest point to center to be selected instead. Given that most PC objects will not be symmetrical, the cube is less suited for more advanced attributes—they can include items such as collision spaces, color density, and clustering. Other attributes across all PCLs in the rendering engine can be preserved as well—for example, objects can be assigned a certain number of points or atoms such that LOD values are normalized at maximum detail. This operation may require sampling the surfaces of the object and adding new points, or removing points from apparent surfaces having an excess of points.

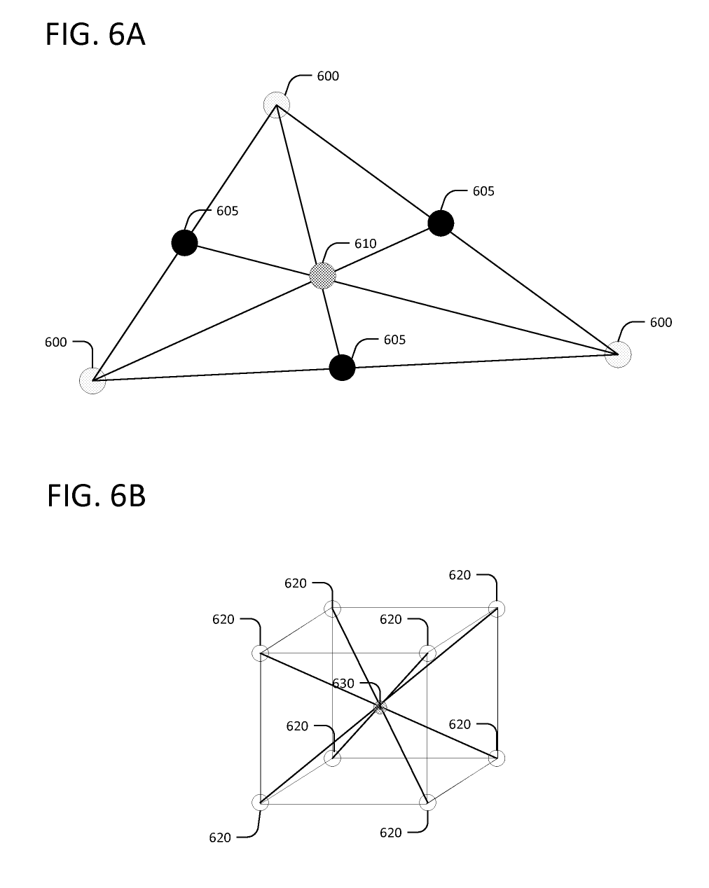

Once the constraints are determined 315, the process of ordering the PCO data starts 320. The ordering process selects an unordered point from the point cloud list 325 for the purpose of attempting to constrain the attribute within an acceptable bound (verified in step 330). The selection of the PCO point 325 is tuned to produce data that will attempt to satisfy the verification step 330. The ordering may be performed with the intent of producing a result approximate to preserving the attribute, but then allow for a correction or interpolation of the point to more fully satisfy the constraint at step 335. One method of constraining the centroid or barycenter attribute is to select a point from the remaining point cloud list that is symmetrically opposite the most recently ordered point with regard to a plane that passes through the barycenter. Similarly, selecting a point that is approximately equidistant to the desired barycenter and also lying on a parallel to the vector of the prior point and the barycenter, as the most recently ordered point will preserve the attribute. See FIG. 6.

If the verification step 330 is successful, then no interpolation or correction is necessary 335, and thus the next point in the PCO data is processed 338, as not all of the PCO data will be ordered for preservation of the selected attribute from step 315. The procedure begins again at 325 for each subsequent remaining point.

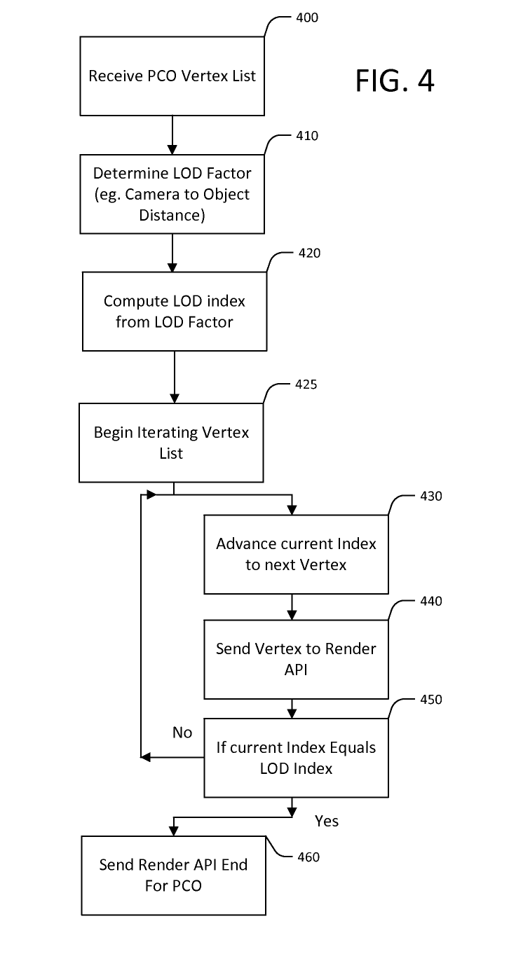

FIG. 4 is a block diagram illustrating a technique of rendering an pre-ordered point cloud list in accordance with an embodiment of the invention. The receiving of a PCO vertex list presumes the existence of a prior precomputed LOD PCO in accordance with FIG. 3, or another embodiment producing or providing a PCO LOD-compliant list, enabling dynamic level of detail. Receiving can include either (1) moving the list into memory, or (2) simply re-using an existing list in cache or main memory via pointer or array. After receiving the list 400, a determination is made as to the LOD factor 410 based on a variety of scene information, but at least including the distance from the camera to the object. An embodiment can include factors such as the presence of multiple objects in the line of sight, occlusion of the object, and total objects in the scene. One embodiment calculates the LOD factor as the division of the length of the vector from the camera to the outermost point of the primary object in view, by the length of the furthest distance where a single PCO point is visible. This distance ratio is then multiplied by a scaling constant for the computational complexity of the scene.

After the LOD factor is determined 410, the LOD index is computed 420 from the LOD factor. In one embodiment, the LOD factor is normalized to the vector space of the LOD PCO list and multiplied by the maximum length of the LOD PCO list. The LOD index 420 will vary from frame to frame during the rendering process as the camera is rotated, translated, scaled and applied under a potentially changing perspective matrix. Scene objects can enter and leave the view, requiring a recalculation of the LOD factor 420. Other considerations in alternative embodiments can include the processor and GPU utilization levels, the frame rate, and changes to application rendering requirements. The LOD index will typically be constrained from 1 to N, where 1 is the first element of the PCO LOD list, and N is the final element.

When the rendering system is ready to send vertices to the graphics pipeline, a start instruction may be issued 425. In the context of using rendering platform such as, for example OpenGL™, the beginning of the vertex list is represented by the glBegin( ) call. The PCO list is iterated 430, 440, 450 according to the points in the reordered vertex list. This process involves advancing the current index to the next vertex in the list 430, sending the vertex to the rendering API 440, and checking if the iteration is complete via a simple less than comparison 450. If the current index equals the LOD index 450, rendering this PCO is complete for this frame. Upon completion, an instruction is sent to the rendering system to complete the PCO vertex list 460. In the context of using a classic rendering platform on, for example OpenGL™, the end of the vertex list is represented by the glEnd( ) call. In one embodiment, the rendering loop 410 through 460 is repeated as necessary to render multiple frames.

FIG. 5A through FIG. 5E illustrate a precomputed mid-point selection dynamic level of detail for a cube object under a regular viewing transform with random points-to-face distribution while maintaining an average barycenter, thus demonstrating an example of how a variable level of detail and variable level of detail index N produce increased visual quality. In FIGS. 5A through 5E, P1-P8 are points 510 and edges 505 representing the object volume on which the point cloud data is demonstrated for a simple cube. The cube geometry of points and edges is shown in the figure to provide a framework for understanding the point cloud data rendered on the surface of the cube. In a practical application, neither the vertices, edges, nor back-facing polygons would be shown—here the hidden surfaces are transparent and polygonal framework are revealed to further show all points of the PCO and the illustrative framework.

FIG. 5A illustrates rendering a point cloud object leveraging dynamic level of detail, with no cloud points rendered.

FIG. 5B illustrates rendering a point cloud object leveraging dynamic level of detail, where the level of detail for this particular application is low (N=58).

FIG. 5C illustrates rendering a point cloud object leveraging dynamic level of detail, where the level of detail is moderate (N=551).

FIG. 5D illustrates rendering a point cloud object leveraging dynamic level of detail, where the level of detail is high (N=1558).

FIG. 5E illustrates rendering a point cloud object leveraging dynamic level of detail, where the level of detail for this particular application is maximum (N=2100).

FIG. 6A illustrates the two dimensional determination of the centroid or barycenter of an object in accordance with an embodiment of the invention. In this figure, vertices 600 have a centroid located at 610. The centroid for a simple triangle is calculated by bisecting the edges connecting the vertices 600. The midpoints of these edges 605 are used to connect each vertex 600 to an edge, the intersection of all three leading to the centroid 610. For objects where the massive body has uniform density, the barycenter will be located at the centroid, and thus this illustration applies to both scenarios.

FIG. 6B illustrates the three dimensional determination of the barycenter of an object in accordance with an embodiment of the invention. This figure expands FIG. 6A into three dimensions, and illustrates the property of the centroid 630 or barycenter for three dimension vertices 620. The centroid or barycenter have desirable properties for purposes of preserving surface density of PCOs, in particular that preserving the average centroid or barycenter where the points are located on the surface of the object produces a uniform surface density distribution and thus precomputed ordering for a PCO. Such a distribution function is applied in FIGS. 5A through 5E. Note that for simple objects such as primary symmetrical shapes including cones, spheres, cubes, point density can be desirably maintained. However, for complex objects such as hyperextended cylinders and bunny rabbits, seeking a uniform density is easily encompassed with alternatives such as a simple algorithm such as the centroid partitioned over the object space. For example, one such algorithm is to divide the PCO volume into a voxel map (such as a 3×3×3 cube having 27 partitioned volumes), and apply the regular 3D centroid algorithm within each voxel volume similar to the cube in FIG. 6B, iterating each volume once per selection of list points. In one embodiment, optimizing the iteration of volumes can occur by selecting the outermost volumes at furthest distance from each other. Alternatively, another embodiment selects the next volume at random, choosing each containing PCO data once per cycle.

The various techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, solid state/flash drives, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide an apparatus that operates to perform the indexing functionality of the present invention. For example, the storage techniques used in connection with the present invention may invariably be a combination of hardware and software.

While the present invention has been described in connection with the embodiments of the various figures, it is to be understood that other similar embodiments may be used or modifications and additions may be made to the described embodiment for performing the same function of the present invention without deviating therefrom. For example, while exemplary embodiments of the invention are described in the context of graphics data in a computing device with a general operating system, one skilled in the art will recognize that the present invention is not limited to PC devices and that a 3D graphics API may apply to any computing device, such as a gaming console, handheld computer (eg. mobile phone, slate, tablet, laptop), portable computer, etc., whether wired or wireless, and may be applied to any number of such computing devices connected via a communications network, and interacting across the network. For example, distributed point cloud rendering may occur over the cloud, and precomputing may occur at any time prior to rendering.

Furthermore, it should be emphasized that a variety of computer platforms, including handheld device operating systems and other application specific operating systems are contemplated, especially as the number of wireless networked devices continues to proliferate. Therefore, the present invention is not limited to any single embodiment, but rather construed in breadth and scope in accordance with the appended claims. What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1-20. (canceled)

21. A method, executable on a computing device having a processor, for rendering a pre-ordered point cloud list that enables dynamic level of detail, the method comprising:
receiving a point cloud list (PCL) representing a three-dimensional (3D) object, the PCL comprising:
a plurality of elements, the individual elements of the plurality of elements being respective PCL points of the 3D object, and the elements being ordered in a sequence wherein:
an attribute of a first representation of the 3D object is a first value when the first representation is rendered from a first quantity of elements from a beginning of the PCL; and
the attribute of other representations of the 3D object rendered from other quantities of elements from the beginning of the PCL is substantially the same as the first value;
computing a level of detail at which a representation of the 3D object is to be rendered;
determining, based on the computed level of detail, a quantity of elements from the beginning of the PCL to be used to render the representation of the 3D object; and
rendering a graphical representation of the 3D object from the determined quantity of elements from the beginning of the PCL.

22. The method of claim 21, wherein the computed level of detail is based on at least one of: a distance from a camera to the 3D object, a number of objects in a scene, or a desired frame rate.

23. The method of claim 21, wherein the computed level of detail is based on a level of detail factor and a length of the PCL.

24. The method of claim 21, wherein the rendering of the graphical representation of the 3D object is performed without conversion of the PCL into one or more polygonal meshes.

25. The method of claim 21, wherein the attribute comprises a 3D barycenter of the 3D object.

26. The method of claim 21, wherein the attribute comprises an average surface density of the 3D object.

27. The method of claim 21, wherein the individual elements of the plurality of elements are also respective points on an external surface of the 3D object.

28. A computing device for rendering a point cloud list with a dynamic level of detail, the computing device comprising:
a processor;
a display configured to display graphical output;
a rendering interface configured to render the graphical output to the display; and
a memory containing instructions executable to cause the computing device to perform operations, the operations comprising:
receiving a point cloud list representative of a three-dimensional object, wherein:
point cloud points of the point cloud list are pre-ordered into a sequence that maintains an attribute of a representation of the three-dimensional object at least substantially constant to within a selected error tolerance during a rendering of the representation of the three-dimensional object from the point cloud points of the point cloud list in accordance with the pre-ordered sequence;
determining a level of detail with which the representation of the three-dimensional object is to be rendered;
identifying a starting point cloud point of the point cloud list;
identifying a stopping point cloud point of the point cloud list that corresponds to the determined level of detail; and
selectively sending point cloud points of the point cloud to the rendering interface based at least in part on the determined level of detail.

29. The computing device of claim 28, wherein the determined level of detail is based on at least one of: a distance from a camera to the three-dimensional object, a number of objects in a scene, or a desired frame rate.

30. The computing device of claim 28, wherein the determined level of detail is based on a level of detail factor and a quantity of point cloud points in the point cloud list.

31. The computing device of claim 28, wherein the starting point cloud points of the point cloud list comprises a least level of detail for the point cloud list.

32. The computing device of claim 28, wherein the attribute of the representation of the three-dimensional object comprises a three dimensional barycenter of the representation of the three-dimensional object.

33. The computing device of claim 28, wherein the attribute of the representation of the three-dimensional object comprises an average surface density of the representation of the three-dimensional object.

34. One or more computer-readable media, comprising at least one of a memory, a disk, a disc, or a device, having computer-executable instructions stored thereon for causing a computing device to perform operations for rendering a representation of a three-dimensional object, the method comprising:
receiving a point cloud list that represents the three-dimensional object, wherein the point cloud list includes a plurality of point cloud points that are arranged in an order that maintains an at least substantially constant attribute for the three-dimensional object during a rendering of the representation of the three-dimensional object from the point cloud list in the order of the point cloud points of the point cloud list;
determining a level of detail for the rendering of the representation of the three-dimensional object from point cloud points of the point cloud list;
identifying a starting point cloud point of the point cloud list;
identifying a stopping point cloud point of the point cloud list based on the determined level of detail and on the order of the point cloud points of the point cloud list; and
rendering the point cloud list, including:
iterating the list from the starting point cloud point of the point cloud list to the stopping point cloud point.

35. The one or more computer-readable media of claim 34, wherein the determined level of detail is based on at least one of: a number of objects in a scene or a desired frame rate.

36. The one or more computer-readable media of claim 34, wherein the determined level of detail is based on a level of detail factor and on a quantity of the point cloud points of the point cloud list.

37. The one or more computer-readable media of claim 34, wherein the starting point cloud point of the point cloud list comprises a least level of detail for the point cloud list.

38. The one or more computer-readable media of claim 34, wherein the at least substantially constant attribute comprises a three-dimensional barycenter of points represented by the point cloud points of the point cloud list such that the three-dimensional barycenter of the representation of the three-dimensional object being rendered from the point cloud list is at least substantially constant regardless of the level of detail for the rendering.

39. The one or more computer-readable media of claim 34, wherein the at least substantially constant attribute comprises an average surface density of points represented by the point cloud points of the point cloud list such that the average surface density of the representation of the three-dimensional object being rendered from the point cloud list is at least substantially constant regardless of the level of detail for the rendering.

40. The one or more computer-readable media of claim 34, wherein the three-dimensional object is a node in a multiple-object point.
